(19) United States
(12) Patent Application Publication
(10) Pub. No.: US 2012/0298277 A1
(43) Pub. Date: Nov. 29, 2012

(54) Tire Bead for a Heavy Civil Engineering Vehicle

(76) Inventor: Lucien Bondu, La Roche Noire (FR)

(21) Appl. No.: 13/515,260

(22) PCT Filed: Dec. 7, 2010
(86) PCT No.: PCT/EP2010/069077

§ 371 Date: Aug. 14, 2012

(30) Foreign Application Priority Data
Dec. 9, 2009 (FR) 0958781

(51) Int. Cl. B60C 15/06

(52) U.S. Cl. 152/541

(57) ABSTRACT

The invention relates to Technique for improving the durability of the beads of a radial tire for a heavy vehicle of the civil engineering type, by reducing the rate of spread of cracks which are initiated on the axially external face of the turned-back portion of carcass reinforcement and then spread through the coating and filling polymer materials. A transition element (28), made of a transition polymer material, is in contact, via its axially internal face, with the coating polymer material of the axially external face of the turned-back portion of carcass reinforcement (21b) and, via its axially external face, with the filling polymer material (26), and the elastic modulus at 10% elongation of the transition polymer material is somewhere between the respective elastic moduli at 10% elongation of the coating polymer material and of the filling polymer material.

The present invention relates to a radial tyre intended to be fitted to a heavy vehicle of the civil engineering type.

Although not restricted to this type of application, the invention will be described more specifically with reference to a radial tire intended to be mounted on a dumper, which is a vehicle that carries material dug out of quarries or open-cast mines. The nominal diameter of the rim of such a tire, within the meaning given by the European Tire and Rim Technical Organization or ETRTO, is equal at minimum to 25″.

The following meanings apply in what follows:

“Meridian plane” is a plane containing the axis of rotation of the tire.

“Equatorial plane” is the plane passing through the middle of the tread surface of the tire and perpendicular to the axis of rotation of the tire.

“Radial direction” is a direction perpendicular to the axis of rotation of the tire.

“Axial direction” is a direction parallel to the axis of rotation of the tire.

“Circumferential direction” is a direction perpendicular to a meridian plane.

“Radial distance” is a distance measured at right angles to the axis of rotation of the tire and from the axis of rotation of the tire.

“Axial distance” is a distance measured parallel to the axis of rotation of the tire and from the equatorial plane.

“Radially” means in a radial direction.

“Axially” means in an axial direction.

“Radially on the inside of or radially on the outside of” means at a shorter, or longer, radial distance.

“Axially on the inside of or axially on the outside of” means at a shorter, or longer, axial distance.

A tire comprises two beads that provide the mechanical connection between the tire and the rim on which it is mounted, the beads being respectively joined, by two sidewalls to a tread intended to come into contact with the ground via a tread surface.

A radial tire more specifically comprises a reinforcement comprising a crown reinforcement, radially on the inside of the tread, and a carcass reinforcement, radially on the inside of the crown reinforcement.

The carcass reinforcement of a radial tire for a heavy vehicle of the civil engineering type usually comprises at least one carcass reinforcement layer made up of metal reinforcing elements coated with a coating polymer material. The metal reinforcing elements are substantially parallel to one another and make an angle of between 85° and 95° with the circumferential direction. The carcass reinforcement layer comprises a main portion of carcass reinforcement, that joins the two beads together and is wound, in each bead, around a bead wire core. The bead wire core comprises a circumferential reinforcing element usually made of metal, surrounded by at least one material which, nonexhaustively, may be made of polymer or textile. The winding of the carcass reinforcement layer around the bead wire core goes from the inside towards the outside of the tire to form a turned-back portion of carcass reinforcement comprising an end. The turned-back portion of carcass reinforcement, in each bead, anchors the carcass reinforcement layer to the bead wire core of that bead.

Each bead comprises a filler element extending the bead wire core radially outwards. The filler element, in any meridian plane, has a substantially triangular cross section and is made of at least one filler polymer material. The filler element may be made of a radial stack of at least two filler polymer materials in contact along a contact surface that intersects any meridian plane along a meridian line. The filler element axially separates the main portion of carcass reinforcement from the turned-back portion of carcass reinforcement.

Each bead also comprises a protection element extending the sidewall radially inwards and axially on the outside of the turned-back portion of carcass reinforcement. The protection element is also at least partially in contact via its axially external face with the rim flange. The protection element is made up of at least one protection polymer material.

Each bead finally comprises a filling element axially on the inside of the sidewall and of the protection element and axially on the outside of the turned-back portion of carcass reinforcement. The filling element is made up of at least one filling polymer material.

A polymer material, after curing, is mechanically characterized by tensile stress-deformation characteristics that are determined by tensile testing. This tensile testing is performed by the person skilled in the art on a test specimen, in accordance with a known method, for example in accordance with international standard ISO 37, and under normal temperature (23±2° C.) and moisture (50±5% relative humidity) conditions defined by international standard ISO 471. The tensile stress measured for a 10% elongation of the test specimen is known as the elastic modulus at 10% elongation of a polymer blend and is expressed in mega pascals (MPa).

A polymer material, after curing, is also mechanically characterized by its hardness. Hardness is notably defined by the Shore A hardness determined in accordance with ASTM D 2240-86.

As the vehicle drives along, the tire, mounted on its rim, inflated and compressed under the load of the vehicle, is subjected to bending cycles, particularly at its beads and its sidewalls.

The bending cycles lead to variations in curvature combined with variations in tension of the metal reinforcing elements in the main portion of carcass reinforcement and the turned-back portion of carcass reinforcement.

The bending cycles in particular lead to stresses and deformations mainly in shear and in compression in the coating and filling polymer materials on the axially external face of the turned-back portion of carcass reinforcement, because of the bending of the bead on the rim flange.

In particular, in the zone where the bead wraps over the rim flange, the bending cycles initiate cracks on the axially external face of the turned-back portion of carcass reinforcement. These cracks spread in the coating polymer material then in the filling polymer material in which they form cavities which, over time, are likely to lead to degradation of the tire requiring it to be replaced. The rate at which the cracks spread is dependent firstly on the amplitude and frequency of the stress and strain deformation cycles and secondly on the rigidities of the polymer materials in the crack zone.

Document JP 2004345414 has already described, in the case of a tire with a radial carcass reinforcement, beads which have a design aimed at preventing cracks generated in the zone of overlap between the turned-back portion of carcass reinforcement and the radially external end of the layer of metal reinforcing elements surrounding the radially internal part of the bead wire core. In the technical solution proposed, an element made of polymer material is inserted between the turned-back portion of carcass reinforcement and the radially external end of the layer of metal reinforcing elements surrounding the radially internal part of the bead wire core.

The inventors have set themselves the objective of improving the durability of the beads of a radial tire for a heavy vehicle of the civil engineering type, by reducing the rate of spread of cracks which are initiated on the axially external face of the turned-back portion of carcass reinforcement and then spread through the coating and filling polymer materials.

According to the invention, this objective has been achieved by:

a tire for a heavy vehicle of the civil engineering type, comprising two beads intended to come into contact with a rim comprising two rim flanges which are at least partially circular,

a carcass reinforcement comprising at least one carcass reinforcement layer made up of metal reinforcing elements coated in a coating polymer material,

the carcass reinforcement layer comprising a main portion of carcass reinforcement which, in each bead, is wound from the inside towards the outside of the tire, around a bead wire core to form a turned-back portion of carcass reinforcement,

each bead comprising a protection element extending a sidewall radially inwards and a filling element which is axially on the inside of the protection element and of the sidewall and axially on the outside of the turned-back portion of carcass reinforcement,

the protection and filling elements respectively consisting of at least a protection polymer material and a filling polymer material,

the filling polymer material having an elastic modulus at 10% elongation that is less than the elastic modulus at 10% elongation of the coating polymer material,

a transition element, made of a transition polymer material, being in contact, via its axially internal face, with the coating polymer material of the axially external face of the turned-back portion of carcass reinforcement and, via its axially external face, with the filling polymer material, and

the elastic modulus at 10% elongation of the transition polymer material being somewhere between the respective elastic moduli at 10% elongation of the coating polymer material and of the filling polymer material.

According to the invention, it is advantageous to have a transition element, made of a transition polymer material, that is in contact, via its axially internal face, with the coating polymer material of the axially external face of the turned-back portion of carcass reinforcement and, via its axially external face, with the filling polymer material. This is because adding a transition element makes it possible to create a gradient of rigidities and locally to limit the levels of stresses and deformations on which the rate of spread of cracks initiated on the axially external face of the turned-back portion of carcass reinforcement and spreading through the coating and filling polymer materials is dependent.

The elastic modulus at 10% elongation of the transition polymer material is advantageously somewhere between the respective elastic moduli at 10% elongation of the coating polymer material and of the filling polymer material with which the transition element is in contact. The progressive decrease in elastic moduli at 10% elongation when moving successively from the coating polymer material to the transition polymer material, and to the filling polymer material, gives a decreasing and gradual rigidity gradient, which makes it possible to reduce the stresses and deformations on the axially external face of the turned-back portion of carcass reinforcement and therefore to slow the spread of cracks.

The greater the difference between the respective elastic moduli at 10% elongation of the coating polymer material and of the filling polymer material, the more significant an advantage afforded by an intermediate elastic modulus at 10% elongation of the transition polymer material. In the studied example of the tire according to the invention, the elastic modulus at 10% elongation of the coating polymer material is equal to 1.6 times the elastic modulus at 10% elongation of the filling polymer material.

It is also advantageous to have the radially external end of the transition element radially on the outside of the straight line passing through the centre of the circle of the rim flange and making an angle of +70° with respect to the axial direction.

It is also advantageous to have the radially internal end of the transition element radially on the inside of the straight line passing through the centre of the circle of the rim flange and making an angle of +40° with respect to the axial direction.

Because the rim of a tire comprising two rim flanges that are symmetric with respect to the equatorial plane of the tire and because each rim flange in its radially outermost portion comprises a circular part, a local frame of reference is defined for each rim flange, the origin of this local frame of reference being the centre of the circle of the rim flange and its axes being two straight lines passing through the centre of the circle of the rim flange and respectively oriented axially towards the inside of the tire and radially towards the outside of the tire.

The angle of a straight line passing through the centre of the circle of the rim flange with respect to the axial direction is the angle that this straight line makes with the axially directed straight line passing through the centre of the circle of the rim flange and directed towards the inside of the tire. This angle is positive if the angle measured from the straight line passing through the centre of the circle of the rim flange and oriented axially towards the inside of the tire, towards the said straight line is measured in the trigonometric direction.

The geometric positions of the ends of the transition element are measured on a tire mounted on its rim, namely inflated to the minimum pressure that ensures correct positioning of the beads of the tire with respect to the rim flanges. By way of example, this minimum pressure may be equal to 10% of the nominal inflation pressure as specified in the ETRTO standard.

The inventors have demonstrated that the zone sensitive to cracking on the axially external face of the turned-back portion of carcass reinforcement was contained between the straight lines passing through the centre of the circle of the rim flange and respectively making a minimum angle equal to +40° and a maximum angle equal to +70° with respect to the axial direction. This is in fact the zone of greatest compression and greatest shear as the bead wraps over the rim flange under the load applied to the tire. As a result, the transition element needs at least to cover this zone of sensitivity to cracking on the axially external face of the turned-back portion of carcass reinforcement, bearing in mind the tolerances on the positioning of the transition element with respect to the turned-back portion of carcass reinforcement, which tolerances are inherent to the manufacturing method.

According to an advantageous embodiment of the invention, the thickness of the transition element is at least equal to the thickness of the coating polymer material.

What is termed the thickness of the transition element is the constant thickness of the transition element measured outside of the tapering regions at the ends of the transition element.

What is termed the thickness of the coating polymer material is the thickness of the coating polymer material measured, on the axially external face of the turned-back portion of carcass reinforcement, from and perpendicular to the axially external generatrix of a cylindrical metal reinforcing element of the turned-back portion of carcass reinforcement.

This minimum thickness of the transition element makes it possible to establish a minimum rigidities gradient, allowing the rate of spread of cracks to be reduced.

The thickness of the transition element is advantageously at most equal to 5 times the thickness of the coating polymer material. This is because the thermal dissipation of the transition polymer material is greater than that of the filling polymer material because of its higher elastic modulus at 10% elongation. As a result, too high a volume of transition polymer material leads to an increase in bead temperature that is damaging to its life, hence the importance of placing an upper limit on the thickness of the transition element.

One advantageous embodiment of the invention is to have the elastic modulus at 10% elongation of the transition polymer material at least equal to 0.9 times and at most equal to 1.1 times the arithmetic mean of the respective elastic moduli at 10% elongation of the coating polymer material and of the filling polymer material. This range of values for the elastic modulus at 10% elongation of the transition polymer material guarantees a minimum gradient of rigidities when moving successively from the coating polymer material, to the transition polymer material, then to the filling polymer material, hence a significant decrease in the rate at which the cracks spread.

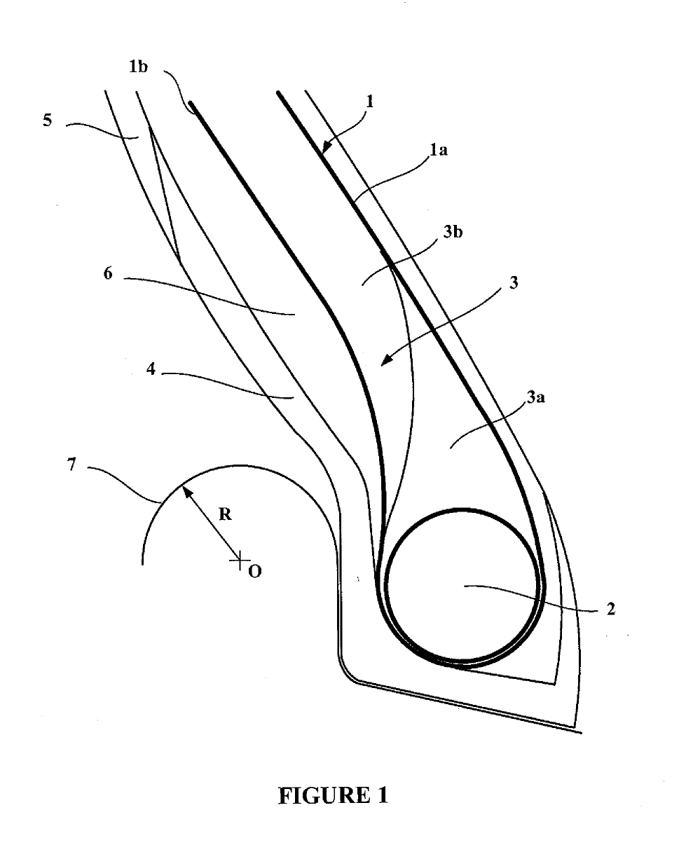

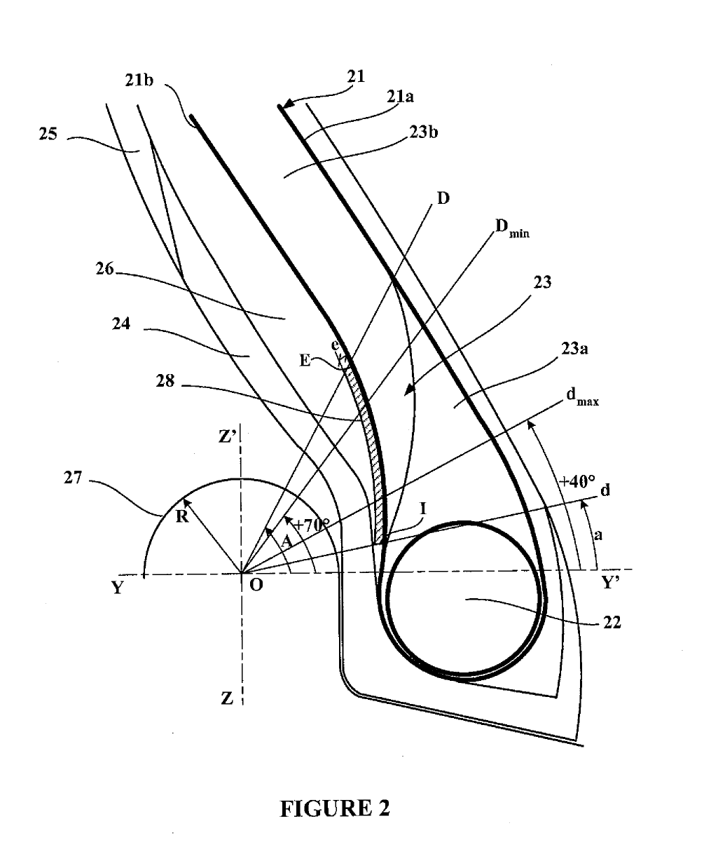

The features of the invention will be more readily understood with the aid of the description of attached FIGS. 1 and 2:

FIG. 1 is a view in cross section on a meridian plane of the bead of a tire for a heavy vehicle of the civil engineering type of the prior art.

FIG. 2 is a view in cross section on a meridian plane of the bead of a tire for a heavy vehicle of the civil engineering type according to the invention.

To make them easier to understand, FIGS. 1 and 2 are not drawn to scale.

FIG. 1 depicts a bead of a tire for a heavy vehicle of the civil engineering type of the prior art, comprising:

a carcass reinforcement comprising a single layer of carcass reinforcement 1 consisting of metal reinforcing elements coated in a coating polymer material, with a main portion of carcass reinforcement 1a wound, from the inside towards the outside of the tire, around a bead wire core 2 to form a turned-back portion of carcass reinforcement 1b,

a filler element 3 extending the bead wire core 2 radially outwards and having, in any meridian plane, a substantially triangular cross section and being made of two filler polymer materials,

a first filler polymer material 3a being radially on the outside and in contact with the bead wire core 2,

a second filler polymer material 3b being radially on the outside and in contact with the first filler polymer material 3a,

a protection element 4 extending a sidewall 5 radially inwards and made of at least one protection polymer material,

a filling element 6 axially on the inside of the protection element 4 and of the sidewall 5 and axially on the outside of the turned-back portion of carcass reinforcement 1b, and made of a filling polymer material.

FIG. 2 depicts a bead of a tire for a heavy vehicle of the civil engineering type according to the invention, comprising:

a carcass reinforcement comprising a single layer of carcass reinforcement 21 consisting of metal reinforcing elements coated in a coating polymer material, with a main portion of carcass reinforcement 21a wound, from the inside towards the outside of the tire, around a bead wire core 22 to form a turned-back portion of carcass reinforcement 21b,

a filler element 23 extending the bead wire core 22 radially outwards and having, in any meridian plane, a substantially triangular cross section and being made of two filler polymer materials,

a first filler polymer material 23a being radially on the outside and in contact with the bead wire core 22,

a second filler polymer material 23b being radially on the outside and in contact with the first filler polymer material 23a,

a protection element 24 extending a sidewall 25 radially inwards and made of at least one protection polymer material,

a filling element 26 axially on the inside of the protection element 24 and of the sidewall 25 and axially on the outside of the turned-back portion of carcass reinforcement 21b, and made of a filling polymer material.

a transition element 28 in contact, via its axially internal face, with the coating polymer material of the axially external face of the turned-back portion of carcass reinforcement and, via its axially external face, with the filling polymer material.

The transition element 28 has a thickness e depicted schematically as constant but which in actual fact is usually tapered at its respectively radially external E and radially internal I ends.

The respective geometric positions of the radially external E and radially internal I ends of the transition element 28 is defined with respect to the local frame of reference, the origin of which is the centre O of the circle of the rim flange 27 and the axes YY′ and ZZ′ of which are two straight lines passing through the centre O of the circle of the rim flange and respectively directed axially towards the inside of the tire and radially towards the outside of the tire. The angle that a straight line passing through the centre O of the circle of the rim flange makes is then said to be positive if measuring from the axis YY′ to the straight line involves measuring in the trigonometric direction.

The radially external E and radially internal I ends of the transition element 28 are situated respectively on the straight lines D and d, making the angles A and a with the axis YY′.

The radially external E and radially internal I ends of the transition element 28 are respectively radially on the outside of the straight line Dₘᵢₙ, making an angle of +70° with respect to the axis YY′, and radially on the inside of the straight line dₘₐₓ, making an angle of +40° with respect to the axis YY′.

The invention has been studied more particularly in the case of a tire for a heavy vehicle of the dumper type of the size 59/80R63. According to the ETRTO standard, the nominal conditions of use of such a tire are an inflation pressure of 6 bar, a static load of 99 tonnes and a distance covered in one hour of between 16 km and 32 km.

The 59/80R63 tire was designed according to the invention, as depicted in FIG. 2.

The angle A of the straight line D passing through the radially external end E of the transition element 28 is equal to +80°, and therefore greater than +70°.

The angle a of the straight line d passing through the radially internal end I of the transition element 28 is equal to +35°, and therefore less than +40°.

The thickness e of the transition element 28 is equal to 1.5 mm and is therefore between the thickness of the coating polymer material that is equal to 1 mm and 5 times the thickness of the polymer coating material.

The elastic moduli at 10% elongation of the coating, transition and filling polymer materials are respectively equal to 6 MPa, 4.8 MPa and 3.5 MPa. Thus the elastic modulus at 10% elongation of the transition polymer material is equal to the arithmetic mean of the respective elastic moduli at 10% elongation of the coating and filling polymer materials.

Finite element calculation simulations have been performed respectively on a reference tire, as depicted in FIG. 1, and on a tire according to the invention, as depicted in FIG. 2. For the reference tire, the elongation of the filling polymer material in the zone with susceptibility to cracking on the axially external face of the turned-back portion of carcass reinforcement 1b, is equal to 1.3 times the elongation of the coating polymer material in contact therewith, these elongations being parallel to the turned-back portion of carcass reinforcement. For the tire according to the invention, the elongation of the transition polymer material 28, in the zone with susceptibility to cracking on the axially external face of the turned-back portion of carcass reinforcement 21b, is equal to 1.1 times the elongation of the coating polymer material. As a result, the rate at which a crack spreads from the coating polymer material to the transition polymer material 28, in the case of the invention, is lower than the rate at which a crack spreads from the coating polymer material to the filling polymer material 6, in the case of the reference tire, because the ratio of the elongation of the transition polymer material 28 to the elongation of the coating polymer material, equal to 1.1, is lower than the ratio of the elongation of the filling polymer material 6 to the elongation of the coating polymer material, equal to 1.3.

The invention should not be interpreted as being restricted to the example illustrated in FIG. 2, but can be extended to other embodiment variants such as, for example and nonexhaustively, concerning the number of transition polymer materials included between the coating polymer material and the filling polymer material.

1. A tire for a heavy vehicle of the civil engineering type, comprising two beads configured to come into contact with a rim comprising two rim flanges which are at least partially circular, a carcass reinforcement comprising at least one carcass reinforcement layer made up of metal reinforcing elements coated in a coating polymer material, the carcass reinforcement layer comprising a main portion of carcass reinforcement which, in each bead, is wound from the inside towards the outside of the tire, around a bead wire core to form a turned-back portion of carcass reinforcement, each bead comprising a protection element extending a sidewall radially inwards and a filling element which is axially on the inside of the protection element and of the sidewall and axially on the outside of the turned-back portion of carcass reinforcement, the protection and filling elements respectively consisting of at least a protection polymer material and a filling polymer material, the filling polymer material having an elastic modulus at 10% elongation that is less than the elastic modulus at 10% elongation of the coating polymer material, wherein a transition element, made of a transition polymer material, is in contact, via its axially internal face, with the coating polymer material of the axially external face of the turned-back portion of carcass reinforcement and, via its axially external face, with the filling polymer material, and wherein the elastic modulus at 10% elongation of the transition polymer material is somewhere between the respective elastic moduli at 10% elongation of the coating polymer material and of the filling polymer material.

2. The tire for a heavy vehicle of the civil engineering type according to claim 1, wherein the radially external end of the transition element is radially on the outside of the straight line passing through the centre of the circle of the rim flange and making an angle of +70° with respect to the axial direction.

3. The tire for a heavy vehicle of the civil engineering type according to claim 1, wherein the radially internal end of the transition element is radially on the inside of the straight line passing through the centre of the circle of the rim flange and making an angle of +40° with respect to the axial direction.

4. The tire for a heavy vehicle of the civil engineering type according to claim 1, wherein the thickness of the transition element is at least equal to the thickness of the coating polymer material.

5. The tire for a heavy vehicle of the civil engineering type according to claim 1, wherein the thickness of the transition element is at most equal to 5 times the thickness of the polymer coating material.

6. The tire for a heavy vehicle of the civil engineering type according to claim 1, wherein the elastic modulus at 10% elongation of the transition polymer material is at least equal to 0.9 times and at most equal to 1.1 times the arithmetic mean of the respective elastic moduli at 10% elongation of the coating polymer material and of the filling polymer material.
